(19) United States
(12) Patent Application Publication
(10) Pub. No.: US 2009/0153099 A1
(43) Pub. Date: Jun. 18, 2009

(54) METHOD OF ELECTRIC ENERGY TRANSFER BETWEEN A VEHICLE AND A STATIONARY COLLECTOR

(75) Inventor: Imad Mahawili, Grand Haven, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: ENERGY RECOVERY TECHNOLOGY, LLC, Grand Haven, MI (US)

(21) Appl. No.: 12/336,006

(22) Filed: Dec. 16, 2008

Related U.S. Application Data
(60) Provisional application No. 61/014,175, filed on Dec. 17, 2007.

(51) Int. Cl. H02J 7/00; H01F 38/14

(52) U.S. Cl. 320/109; 307/104

(57) ABSTRACT

A vehicle includes an amplifier, a vehicle battery for supplying electrical power to the amplifier, a frequency generator for generating an input signal for the amplifier, and a control system. The amplifier is in communication with the frequency generator for selectively increasing the power of the input signal and outputting an output signal having a frequency and an increased power than the input signal. The control system includes a sensor for detecting the presence of a stator exteriorly of the vehicle and is in communication with the frequency generator and the amplifier. The vehicle also includes a magnetic field generating device for generating a magnetic field. The amplifier is in communication with the magnetic field generating device, and the magnetic field generating device generates a magnetic field in response to receiving the output signal from the amplifier.

The present application claims the benefit of U.S. provisional application, entitled A METHOD OF ELECTRIC ENERGY TRANSFER BETWEEN A VEHICLE AND A STATIONARY COLLECTOR, Ser. No. 61/014,175, filed Dec. 17, 2007.

### TECHNICAL FIELD AND BACKGROUND OF THE INVENTION

Today, most batteries in an internal combustion engine vehicle are charged via alternators that extract their energy from the engine. More recently, hybrid engines use regenerative braking to charge their batteries. The challenge of the emerging electric vehicles is their need to be plugged into an electric source to be recharged. However, this typically requires the vehicle to be stationary and, further, require interconnection with the electric source. Similarly, while great strides have been made to increase the energy efficiency of vehicles, there are still inherent energy inefficiencies and thermodynamic Carnot cycle limitations and waste. For example, when a vehicle comes to a full stop from any speed or is driven down a hill or an incline, energy is wasted because it is not recovered.

Consequently, there is a need for a system that can transfer energy between a moving vehicle and a stationary source/sink of electricity to either charge the vehicle battery or to harness energy from the vehicle that may otherwise be wasted.

### SUMMARY OF THE INVENTION

The method and system of the present invention enables the transfer of electricity from a vehicle battery, which has been charged from engine waste idle power and regenerative brakes, to an electric storage device or electric supply system, such as the electric power grid, while the vehicle is in motion or stationary without any physical interconnections. The method and system of the present invention may also be used in reverse to charge an electric vehicle battery without any physical interconnections and further while the vehicle is stationary or in motion.

In one form of the invention, a vehicle includes an amplifier, a vehicle battery for supplying electrical power to the amplifier, a frequency generator for generating an input signal for the amplifier, which selectively increases the power of the input signal and outputs an output signal having the same frequency of the input signal but with increased power. The vehicle further includes a control system, which includes a sensor for detecting the presence of a stator exteriorly of the vehicle and which is in communication with the frequency generator and the amplifier, and a magnetic field generating device for generating a magnetic field. The amplifier is in communication with the magnetic field generating device, which generates an oscillating magnetic field in response to receiving the output signal from the amplifier.

In one aspect, the frequency generator comprises a variable frequency generator. For example, the control system may generate input signals to the generator to vary the frequency of the generator.

In another aspect, the magnetic field generating device comprises a metal coil and a metal core. For example, the core may comprise a metal core having a high nickel content.

In another aspect, the vehicle includes a housing, with the housing supporting the magnetic field generating device and mounting it to the vehicle. For example, the magnetic field generating device has a bottom side, with the magnetic generating device being encased by the housing on all sides except the bottom side.

According to yet other aspects, the control system further including a sensor, which detects the speed of the vehicle. Further, the control system is configured to generate a drive signal to the amplifier when the sensor senses the vehicle is stationary.

In another form of the invention, an energy recovery system includes a vehicle, a control system, and a magnetic field generating device in communication with the control system and producing a variable magnetic field in response to signals from the control system. The magnetic field generating device is mounted to the vehicle, and the system further includes a circuit with a stationary conductor adapted for placing in or adjacent the vehicle wherein the magnetic field, which is generated by the magnetic field generating device, induces alternating current flow through the circuit when the vehicle is in proximity to the conductor. Consequently, the magnetic field generating device is configured to generate current flow in the stationary conductor even when the vehicle is stationary.

In one aspect, the control system includes a frequency generator, which generates an oscillating signal, which is used to produce the variable magnetic field.

In a further aspect, the system also includes an amplifier for increasing the power of the signal from the frequency generator.

According to yet a further aspect, the circuit includes an energy storage device for storing electrical energy created by the induced current flow.

In yet another form of the invention, an energy transfer system includes a vehicle, a signal generating device at the vehicle, a stationary magnetic field generating device located exteriorly of the vehicle, and a control system for controlling and powering the magnetic field generating device. A recharging circuit with a conductor and an energy storage device is provided at the vehicle, with the recharging circuit and the control system in communication with a user input. The control system selectively drives the magnetic field generating device in response to receiving a signal from the signal generator to transfer energy to the conductor to thereby recharge the energy storage device on the vehicle.

In one aspect, the control system is configured to generate an alternating current and to power the magnetic field generating device with the alternating current.

Accordingly, the present invention provides an energy transfer system that can download power from a vehicle for use exteriorly of the vehicle or upload power to a vehicle to recharge the vehicle battery.

These and other objects, advantages, purposes, and features of the invention will become more apparent from the study of the following description taken in conjunction with the drawings.

### DETAILED DESCRIPTION OF THE DRAWINGS

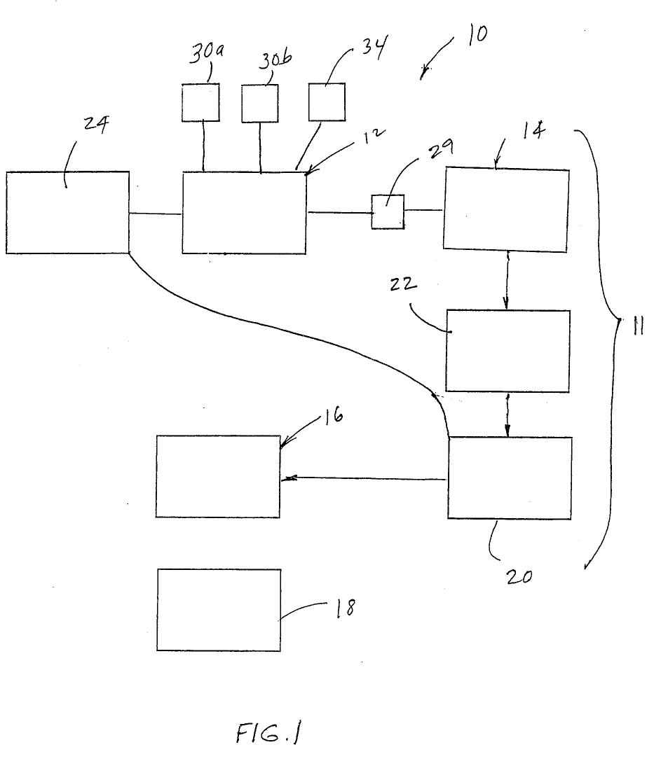

FIG. 1 is a schematic drawing of the electric energy transfer system of the present invention;

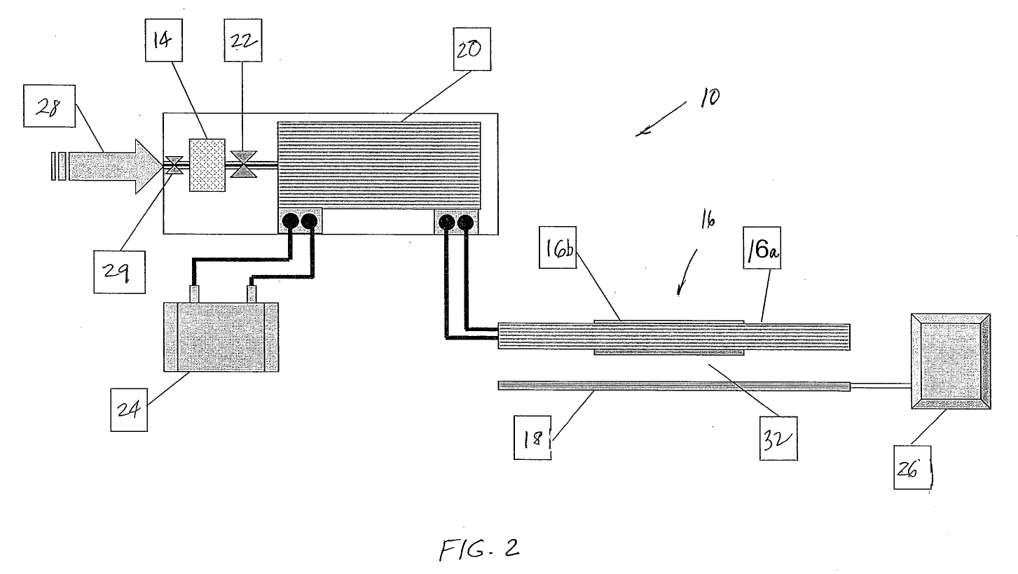

FIG. 2 is a schematic drawing of the electric energy transfer system from a vehicle to a stationary collector;

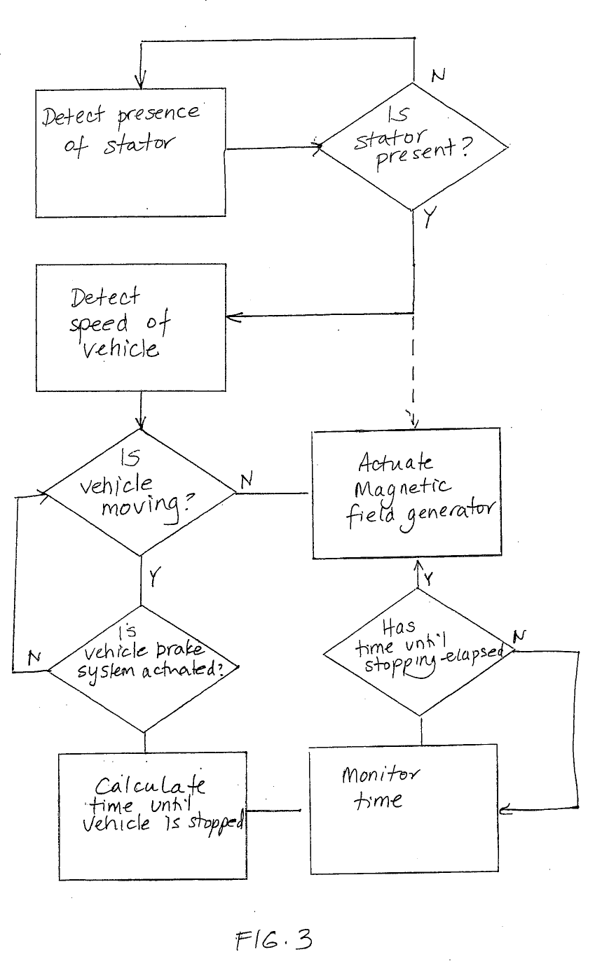

FIG. 3 is a flowchart of the method of transferring energy from the vehicle to a stationary collector;

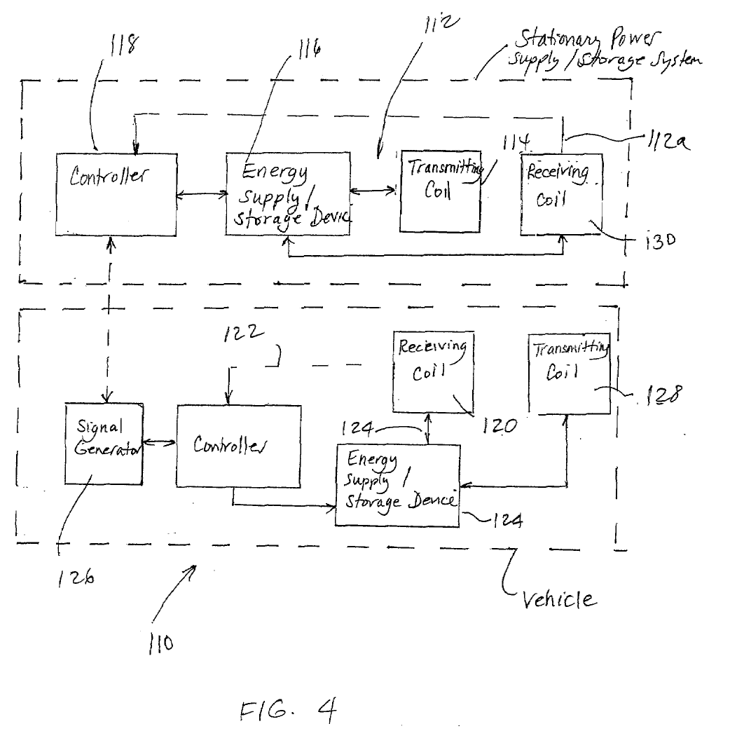

FIG. 4 is a schematic drawing of the electric energy transfer system between a stationary receiver or transmitter and a vehicle; and

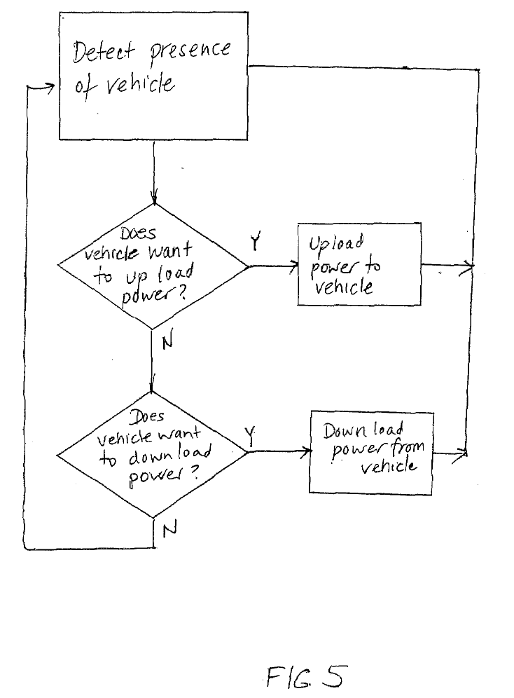

FIG. 5 is a flowchart of the method of transferring energy between a stationary receiver or transmitter and a vehicle.

### DETAILED DESCRIPTION OF THE PREFERRED EMBODIMENTS

Referring to FIG. 1, the numeral 10 generally designates an electric energy transfer system for transferring energy between a vehicle, such as an automobile, truck, train or the like, and a stationary collector. As will be more fully described below, system 10 allows energy to be transferred between a stationary collector 12 and a vehicle 14 using inductive coupling when the vehicle is stationary or moving.

As best seen in FIG. 1, system 10 includes a control system 11 with a controller 12, a frequency generator 14, and a magnetic field generating device 16, which is selectively powered by control system 11 to generate a fluctuating or oscillating magnetic field to thereby induce current flow in a stationary collector 18 when magnetic field generating device 16 is in close proximity to collector 18. System 10 is mounted to the vehicle and further with magnetic field generating device 16 mounted in a manner to position magnetic field generating device 16 in close proximity to collector 18 when an energy transfer is desired. Optionally, the magnetic field generating device 16 is housed in a housing which encapsulates all sides of the magnetic field generating device except for one side so that only one side, such as the bottom side, of the magnetic field generating device is exposed, which may better focus the magnetic field. For further details and examples of how magnetic field generating device 16 may be mounted to a vehicle and examples of suitable collectors, reference is made to copending applications: Ser. No. 10/880,690, filed Jun. 30, 2004, entitled ENERGY RECOVERY SYSTEM; Ser. No. 11/454,948, filed Jun. 16, 2006, entitled ENERGY RECOVERY SYSTEM; Ser. No. 11/828,686, filed Jul. 26, 2007, entitled CIRCUIT MODULE; Ser. No. 12/248,553, filed Oct. 9, 2008, entitled ENERGY RECOVERY SYSTEM; and Ser. No. 61/122,660, filed Dec. 15, 2008, entitled ACTIVATION ASSEMBLY FOR AN ENERGY RECOVERY SYSTEM, which are incorporated by reference herein in their entireties.

To increase the strength of the signal from frequency generator 14, control system 11 further includes an amplifier 20 and an optional pre-amplifier 22, which comprises an electronic signal conditioning preamplifier that adjusts the frequency generator to the right voltage and impedance prior to connection to amplifier 20. Amplifier 20 is powered by a battery 24, such as the vehicle battery, which also powers controller 12.

As noted above, as best seen in FIG. 2, energy transfer system 10 is adapted to transfer energy to stationary collector 18, namely a stator, which may be mounted in the ground or road surface. Stationary collector 18 may be located in the path of a vehicle or adjacent the path of a vehicle, so that when magnetic field generator 16 passes by stationary collector 18, current flow is induced in the stationary collector, which is transmitted to an energy supply for storage and later use, as described in the referenced applications. To generate the magnetic field, magnetic field generator 16 includes metal a core 16a and a coil 16b. It should be understood that the type of core and the number of windings of the coil may be varied to adjust the strength of the magnetic field generated by magnetic field generator 16.

As noted above, system 10 is configured to transfer energy from magnetic field generator 16 to stationary collector 18 even when the vehicle is stationary, or when the vehicle is moving. In the illustrated embodiment, frequency generator 14 generates frequency signals that are amplified by amplifier 20 and then transmitted to magnetic generating device 16 so that magnetic field generator generates an oscillating magnetic field. Amplifier 20 is capable of delivering power in a range of a few watts to many thousands of watts, for example from 2000 watts to 6000 watts. The frequency generator can produce a wide variety of frequency ranges but typically produces a frequency in the range of 10 to 20000 Hz. Generator 14 is best selected for optimal power transfer and performance of the total system.

Referring to FIG. 2, a collector 18 is mounted in the ground or road surface so that when the magnetic field generating device 16 is in close proximity and, further is powered by amplifier 18, magnetic field generating device 16 will generate an oscillating magnetic field that will induce current flow through collector 18. Collector 18 is coupled to an energy storage device 26 for storing energy generated by the inductive coupling between the magnetic field generator 16 and collector 18.

Collector 18, for example may comprise a coil that is embedded into or mounted on the road surface or the ground, for example adjacent train tracks. The coil may be made from appropriate non-ferrous materials. For example, collector 18 may comprise an array of independent stators, with each independent stator including a coil unit with a rectifier. Further, each stator may be coupled or “plugged” into a shared electrical circuit, such as described in application Ser. No. 11/454,948, filed Jun. 16, 2008, entitled ENERGY RECOVERY SYSTEM and Ser. No. 12/305,024, filed Dec. 16, 2008, entitled ENERGY RECOVERY SYSTEM. In this manner, each stator may be removed for repair or replacement, without any measurable loss of captured energy. For suitable stator coils, reference is made to copending application Ser. No. 10/880,690, filed Jun. 30, 2004, entitled ENERGY RECOVERY SYSTEM; Ser. No. 11/454,948, filed Jun. 16, 2006, entitled ENERGY RECOVERY SYSTEM; and Ser. No. 11/828,686, filed Jul. 26, 2007, entitled CIRCUIT MODULE. Further, as described in copending application Ser. No. 11/828,686, filed Jul. 26, 2007, entitled CIRCUIT MODULE, collector 18 may use a rectifier circuit to rectify the voltage. However, it should be appreciated that the collector may be used without a rectifier for the production of alternating voltage. Alternately, collector 18 may be coupled to a power conditioning device or a storage device 26, which is selected to meet the desired electric transmission application, namely direct interconnection to the grid, storage, or local hydrogen generation, such as described in the above referenced copending applications.

As noted above, controller 12 generates a signal 28 (FIG. 2) to generator 14 to initiate the process. Optionally signal 28 initiates the electromagnetic activation via a switch 29. For example, controller 12 may comprise the vehicle computer and, further, is optionally configured to sense the speed of the vehicle and, further, the presence of the collector 18 before actuating generator 14. For example, controller 12 may be in communication with a plurality of sensors, such as sensor 30a that detects the speed of the vehicle and sensor 30b, which detects the presence of the collector. For example, controller 12 may be programmed to send a signal to generator 14 upon detecting that the vehicle is stopped or slowing. Further, controller 12 may be configured to only send the signal to generator 14 to initiate the activation process when or after the collector is detected. Alternately, controller 12 may actuate the generator 14 while the vehicle is still in motion upon the detection of the collector. In yet another form, controller 12 may incorporate a processor, which calculates the projected stopping time of the vehicle based on the speed of the vehicle and the time that braking was initiated to determine when the actuation signal to the generator is to be generated and then activating the generator 14 at the projected stopping time.

As will be understood, when controller 12 sends an actuating signal to generator 14, magnetic field generator 16 receives an amplified signal from amplifier 20, and more specifically an amplified sinusoidal signal. This generates the oscillating magnetic field in the magnetic field generator 16, which can be intensified by the use of certain metal in the core 16a. For example, suitable metals include iron or iron alloys to maximize the induced field strength. Other suitable metals include metals with high nickel content, such as commercially available Kovar. However, it should be appreciated that the material forming core 16a may be varied and is not limited to the examples provided herein. As would be understood, the induced varying voltage induced in collector 18 is determined by the number of turns of coil 16b, the size of the windings of coil 16b, the permeability of core 16a, the air gap 32 between electromagnetic field generator 16 and collector 18, the number and size of windings in the collector, the material of the collector line, and the applied voltage to the magnetic field generator 16 from amplifier 20.

As noted above, controller 12 may incorporate a microprocessor with software for controlling the energy transfer system. For example, referring to FIG. 3, controller 12 may include a processor and storage device, which includes software that monitors sensors 30a and 30b to determine the speed of the vehicle and detect the presence of a collector. In the illustrated embodiment, if the collector is present, the software will check the status of sensor 30a to determine the speed of the vehicle. If the vehicle is moving, the software will determine whether the vehicle brake system has been actuated using sensor 34. If the brake system has been actuated, the software will determine the time T1 until the vehicle will be stationary based on the braking system actuation and the speed of the vehicle. The software will continue to monitor the time until such time that the time exceeds or is equal to T1 at which point, the software may initiate the actuation of the magnetic field generator by generating signals to generator 14. Further, as described in the copending application, the software may be configured to move the magnetic field generator in the case of a movable magnetic field generator to a deployed position. If a collector is not detected, the processor will continue to monitor the presence of a collector until such time a collector is detected. Alternately, as noted above, controller 12 may simply monitor for the presence of the collector and initiate the activation process. Other conditions other than stopping may also be included in the activation process, such as downhill motion or speed transitions, for example when the vehicle changes its speed or comes to a complete stop, as noted.

Referring to FIG. 4, in an alternate embodiment, energy transfer system 110 may be configured to transfer energy from a stationary magnetic field generator 112, which is embedded or mounted, for example, on or in a road surface, to a vehicle to recharge the vehicle's battery. Further, as will be more fully described below, the system may also be configured to transfer energy from the vehicle back to the location of the magnetic field generator. Referring to FIG. 4, stationary magnetic field generator 112 includes a transmitting circuit 112a with a transmitting coil 114, which is coupled to an energy supply, such as a battery 116. Further, energy transmitting circuit 112a includes a controller 118, which is in communication with energy supply 116 to actuate the energy supply to thereby generate current flow through the circuit 112a. When energy is supplied to circuit 112a, transmitting coil 114 will generate a magnetic field, which will induce current flow in receiving coil 120 of receiving circuit 122 mounted to the vehicle when the receiving coil is in close proximity to transmitting coil 114. Receiving circuit 122 is coupled to a rechargeable vehicle battery 124 so that when current flow is induced in circuit 122, circuit 122 will charge the vehicle battery. Optionally, circuit 112a is an AC circuit so that the transmitting coil 114 generates a variable magnetic field to thereby induce an alternating magnetic field in receiving coil 120, which generates an alternating current in circuit 122. Further, optionally, circuit 122 includes a rectifier (not shown) to generate a direct current flow into vehicle battery 124. For example, transmitting circuit 112a may be located in a predetermined location where a vehicle user may wish to recharge their battery, for example, at a filling station, or at other designated locations.

Furthermore, to limit actuation of circuit 112a to when a vehicle is in the specific location for recharging its battery, controller 118 may be configured to actuate energy supply 116 only when the vehicle is present. For example, vehicle V may include a signal generator 126, such as an RF transmitter, which generates a signal that is transmitted to controller 118, which includes, for example an RF receiver, to indicate the presence of the vehicle. Furthermore, the signal may carry information relative to the vehicle, for example, vehicle identification or the like. For example, the signal generator may be a signal generator commonly used in RF toll collection systems so that the signal may also transfer information relative to a prepaid account or to a credit card. In this manner, when the vehicle operator charges the vehicle's battery, the vehicle operator may be charged for the energy upload. Vehicle V may also incorporate a user input, which is in communication with the signal generator so that the operator may select to initiate the process. For example a suitable user input device may include a button, switch, or other device that may generate actuation signals to the signal generator or actuation signals to the vehicle computer, which initiates the actuation of the signal generator. Alternately, the signal may be transmitted through a transmitting coil 128 incorporated into circuit 122, which provides inductive data transmission to a corresponding receiving coil 130, which is incorporated into circuit 112a and which generates signals to controller 118 to transmit the data transmitted between transmitting coil 128 and receiving coil 130.

Alternately, the transmitting coil 128 may be used to transmit energy to receiving coil 130 so that system 110 can either download energy from circuit 112a or upload energy to circuit 112a. Referring to FIG. 5, controller 118 may include a microprocessor and memory or storage device, which incorporates software to manage the energy transmission. For example, the software may be configured to detect the presence of a vehicle, for example, when controller 118 receives signals from the vehicle as described above. Further, as noted, circuit 112a may be configured as a transmitting or receiving circuit, in which case, controller 118 may be configured to detect whether the vehicle wishes to upload or download power. Therefore, the signal generator of the vehicle may be configured to transmit a signal that indicates whether the vehicle wishes to upload or download power. Again, this may be selected by a user using the user input device. Upon determining that the vehicle wishes to upload power, controller 118 optionally determines the identification of the vehicle (from the transmitted data) and stores the identification of the vehicle so that when the energy is uploaded to the vehicle, the occurrence of an energy uploaded to the vehicle can be associated with the vehicle identification and stored for later use, such as for billing or credit. In addition to controlling and optionally documenting an upload of energy to the vehicle, controller 118 may further measure the energy uploaded to the vehicle so that the amount of energy uploaded to the vehicle may be associated and stored with the vehicle identification. If the controller 118 determines that the vehicle wishes to download energy to the circuit, controller may likewise determine whether the vehicle has identification based on the signals received from the signal generator from vehicle V and, further, configure circuit 112a so that circuit 112a acts as a receiving circuit to store energy at energy storage device 116. Again, controller 118 may determine the amount of energy received by energy storage device 116 and, further, associate the amount of energy received from storage device 116 with the vehicle identification number.

It should be understood that when the energy transmission circuit operates as a receiving circuit as opposed as a transmitting circuit, the number of coils may be varied. Therefore, to achieve this, the energy transmitting circuit may incorporate two coils, one for transmitting and one for receiving, with each coil having a specific number of coils needed to optimize the transfer or receipt of energy and/or data.

While several forms of the invention have been shown and described, other forms will now be apparent to those skilled in the art. Therefore, it will be understood that the embodiments shown in the drawings and described above are merely for illustrative purposes, and are not intended to limit the scope of the invention, which is defined by the claims, which follow as interpreted under the principles of patent law including the doctrine of equivalents.

The embodiments of the invention in which an exclusive property right or privilege is claimed are defined as follows:

1. A vehicle comprising:
an amplifier;
a vehicle battery for supplying electrical power to said amplifier;
a frequency generator generating an input signal for said amplifier, said input signal having a frequency;
said amplifier in communication with said frequency generator for selectively increasing the power of said input signal and outputting an output signal having said frequency and an increased power than said input signal;
a control system, said control system including a sensor for detecting the presence of a stator exteriorly of the vehicle and in communication with said frequency generator and said amplifier; and
a magnetic field generating device for generating a magnetic field, said amplifier in communication with said magnetic field generating device, and said magnetic field generating device generating a magnetic field in response to receiving said output signal from said amplifier.

2. The vehicle according to claim 1, wherein said frequency generator comprises a variable frequency generator.

3. The vehicle according to claim 2, wherein said control system generates input signals to said generator to vary the frequency of said frequency generator.

4. The vehicle according to claim 1, wherein said magnetic field generating device comprises a metal coil and a metal core.

5. The vehicle according to claim 4, wherein said core comprises a metal core having a high nickel content.

6. The vehicle according to claim 1, further comprising a housing, said housing supporting and mounting said magnetic field generating device to said vehicle.

7. The vehicle according to claim 6, wherein said magnetic field generating device has a bottom side, and said magnetic generating device being encased by said housing on all sides except the bottom side.

8. The vehicle according to claim 1, said control system further including a sensor, said sensor detecting the speed of the vehicle.

9. The vehicle according to claim 8, wherein said control system is configured to generate a drive signal to said amplifier when said sensor senses said vehicle is stationary.

10. An energy transfer system comprising:
a vehicle;
a control system;
a magnetic field generating device in communication with said control system and producing a variable magnetic field in response to signals from said control system, said device mounted to said vehicle; and
a circuit, said circuit including a stationary conductor adapted for placing in or adjacent the vehicle wherein the magnetic field of said magnetic field generating device induces alternating current flow through said circuit when said vehicle is in proximity to said conductor, wherein said magnetic field generating device is configured to generate current flow in said stationary conductor even when said vehicle is stationary.

11. The energy transfer system according to claim 10, wherein said control system includes a frequency generator, said frequency generator producing a signal, said signal generating current flow through said magnetic field generating device.

12. The energy transfer system according to claim 11, further comprising an amplifier for increasing the power of the signal from said frequency generator.

13. The energy transfer system according to claim 12, wherein said circuit forms an AC circuit.

14. The energy transfer system according to claim 13, wherein said circuit includes an energy storage device.

15. An energy transfer system comprising:
a vehicle, said vehicle including a signal generating device;
a stationary magnetic field generating device located exteriorly of said vehicle;
a non-vehicle-based control system for controlling and powering said stationary magnetic field generating device; and
a vehicle-based recharging circuit having a vehicle-based conductor and a vehicle-based energy storage device provided at said vehicle, and said control system driving said stationary magnetic field generating device in response to receiving a signal from said signal generator to thereby generate a magnetic field to transfer energy to said vehicle-based conductor to thereby recharge said vehicle-based energy storage device on the vehicle.

16. The energy transfer system according to claim 15, wherein said control system is configured to generate an alternating current and powering said magnetic field generating device with said alternating current.

17. The energy transfer system according to claim 15, wherein said vehicle comprises an automobile.

18. The energy transfer system according to claim 15, further comprising a use input in communication with said signal generator, said signal generator device generating said signal in response to said user input.

19. The energy transfer system according to claim 18, wherein said user input comprises a button or a switch.

20. The energy transfer system according to claim 15, further comprising a stationary conductor, said vehicle including a vehicle-based magnetic field generating device and a vehicle-based control system for controlling and powering said vehicle-based magnetic field generating device, said signal comprising a first signal, and said signal generating a second signal, and said non-vehicle-based control system driving said stationary magnetic field generating device in response to receiving said first signal, and said vehicle-based control system driving said vehicle-based magnetic field generating device in response to said second signal wherein the magnetic field is generated by said vehicle-based magnetic field generating device generates current flow in said stationary conductor when said vehicle is in close proximity to said stationary conductor.

21. The energy transfer system according to claim 20, further comprising a user input device, said user input device in communication with said signal generator, and said signal generator generating said first signal or said second signal in response to input from said user input device.

22. The energy transfer system according to claim 20, wherein said first signal includes vehicle identification data, and said non-vehicle-based control system measures the amount of energy transferred to the vehicle and associate the amount with the vehicle identification data.

23. The energy transfer system according to claim 22, wherein said non-vehicle-based control system includes a memory device, said amount of energy transferred to the vehicle and associated vehicle identification being stored in memory device.
